(19) United States
(12) Patent Application Publication
(10) Pub. No.: US 2012/0291604 A1
(43) Pub. Date: Nov. 22, 2012

(54) APPARATUS FOR CUTTING SHEET MATERIAL

(75) Inventor: Vincent T. Kozyrski, Plainville, CT (US)

(73) Assignee: THE FLETCHER-TERRY COMPANY, LLC, Farmington, CT (US)

(21) Appl. No.: 13/111,569

(22) Filed: May 19, 2011

(51) Int. Cl. B26D 7/20; B26D 7/02

(52) U.S. Cl. 83/452; 83/859

(57) ABSTRACT

An apparatus for cutting a workpiece sheet, which sheet includes a surface, is provided. The apparatus includes a frame, a blade carriage, and a channeled cutting surface. The frame extends between a first end and a second end, and frame includes a carriage bearing surface that extends between the second end and the first end. The blade carriage has a frame bearing surface, which surface is configured to mate with the carriage bearing surface. The blade carriage is selectively attachable to the frame such that the carriage bearing surface and the frame bearing surface are engaged with one another. The channeled cutting blade is mounted to the blade carriage, and includes an interior surface and an exterior surface. The frame and the blade carriage are relatively positionable such that at least a portion of the channeled cutting blade extends outwardly from the frame an amount that permits the cutting blade to engage and cut a channel in the surface of the workpiece sheet.

### BACKGROUND OF THE INVENTION

1. Technical Field

This invention relates to devices for cutting semi-rigid sheet materials in general, and to such devices that include clamping devices and the ability to cut a variety of different material types in particular.

2. Background Information

There are numerous devices known to the public relating to sheet material cutters that utilize a cutter head operable to move linearly across a workpiece in sheet form. The existing devices suffer from various shortcomings including, limited or no ability to clamp a workpiece, substantial limitations regarding the types of sheet materials that can be cut, or a lack of fine positional adjustability. In short, the sheet material cutting devices currently known to the public possess shortcomings that affect the performance of the devices.

What is needed is a device that can cut a variety of different types of workpiece materials, one that effectively clamps the workpiece, and one that possesses desirable adjustability.

### DISCLOSURE OF THE INVENTION

According to an aspect of the present invention, an apparatus for cutting a workpiece sheet, which sheet includes a surface, is provided. The apparatus includes a frame, a blade carriage, and a channeled cutting surface. The frame extends between a first end and a second end, and frame includes a carriage bearing surface that extends between the second end and the first end. The blade carriage has a frame bearing surface, which surface is configured to mate with the carriage bearing surface. The blade carriage is selectively attachable to the frame such that the carriage bearing surface and the frame bearing surface are engaged with one another. The channeled cutting blade is mounted to the blade carriage, and includes an interior surface and an exterior surface. The frame and the blade carriage are relatively positionable such that at least a portion of the channeled cutting blade extends outwardly from the frame an amount that permits the cutting blade to engage and cut a channel in the surface of the workpiece sheet.

According to another aspect of the present invention, a workpiece sheet cutting device is provided that includes a frame member, a track, a clamp assembly, and a cutter head assembly. The track is attached to the frame member. The clamp assembly is operable to selectively fix the workpiece sheet to the frame member. The cutter head assembly is linearly translatable along the track. The cartridge is selectively attachable to the cutter head assembly. The cartridge includes a frame, a blade carriage, and a channeled cutting surface. The frame extends between a first end and a second end, and frame includes a carriage bearing surface that extends between the second end and the first end. The blade carriage has a frame bearing surface, which surface is configured to mate with the carriage bearing surface. The blade carriage is selectively attachable to the frame such that the carriage bearing surface and the frame bearing surface are engaged with one another. The channeled cutting blade is mounted to the blade carriage, and includes an interior surface and an exterior surface. The frame and the blade carriage are relatively positionable such that at least a portion of the channeled cutting blade extends outwardly from the frame an amount that permits the cutting blade to engage and cut a channel in the surface of the workpiece sheet.

An advantage provided by the present apparatus for cutting a workpiece sheet is versatility. The cutter head assembly of the present apparatus is operable to mount a plurality of different cutter cartridges, including cartridges having a static cutting blade and cartridges having one or more rotary cutting wheels. As a result, the present apparatus can cut a wide variety of different sheet materials with a single cutter head assembly.

Another advantage provided by the present apparatus is the adjustability provided by a squaring mechanism. The triangular wedge of the squaring mechanism provides much finer adjustability than is possible with adjustment accomplished, for example, by a threaded bolt alone. The squaring mechanism can also be used to skew the workpiece should that be desire.

Another advantage provided by the present apparatus is that the clamp assembly self-maintains in a deployed position. Consequently, after the clamp assembly is deployed, the operator is free to use both hands to perform other functions; e.g., use both hands to pull the cutter head assembly across the workpiece when the apparatus is used in manual mode. Alternatively, if the operator desires to use only slight pressure in clamping the workpiece, the clamp assembly can be actuated by hand without utilizing the detented deployed position.

### BRIEF DESCRIPTION OF THE DRAWINGS

FIG. 1 is a planar view of the present device for cutting sheet material.

FIG. 2 is a side view of the present device for cuffing sheet material.

FIG. 3A is a sectional view of the vertical frame assembly along section line 3-3, showing the clamp bar in a retracted position.

FIG. 3B is a sectional view of the vertical frame assembly along section line 3-3, showing the clamp bar in a deployed position.

FIG. 4A is a diagrammatic side view of the vertical frame assembly, illustrating the clamp assembly with the clamp bar in a retracted position.

FIG. 4B is a diagrammatic side view of the vertical frame assembly, illustrating the clamp assembly with the clamp bar in a deployed position.

FIG. 5A is a planar top view of the biasing assembly.

FIG. 5B is a planar side view of the biasing assembly.

FIG. 6 is a sectional view of the horizontal frame assembly cut along section line 6-6.

FIG. 7 is a sectional view of the horizontal frame assembly cut along section line 7-7.

FIG. 8 is a partial planar view of the horizontal frame assembly, including the squaring mechanism.

FIG. 9A is a planar view of the cutter head assembly with a glass scoring cartridge embodiment inserted, with the cartridge and arm in the lifted/retracted position.

FIG. 9B is a planar view of the cutter head assembly with a glass scoring cartridge embodiment inserted, with the cartridge and arm in the deployed position.

FIG. 10A is a top view of the cutter head assembly with a rotary cutter wheel cartridge inserted.

FIG. 10B is a side view of the cutter head assembly with a rotary cutter wheel cartridge inserted.

FIG. 10C is an end view of the cutter head assembly with a rotary cutter wheel cartridge inserted.

FIG. 11 is a planar view of a cartridge embodiment with a static cutting blade.

FIG. 12 is a planar view of a cartridge embodiment with a glass scoring wheel.

FIG. 13 is a planar view of a cartridge embodiment with a pair of rotary cutting wheels.

FIG. 14 is an end view of the cartridge shown in FIG. 13.

FIG. 15 is a diagrammatic sectional view of a rotary cutter wheel embodiment.

FIG. 16 is a diagrammatic sectional view of a rotary cutter wheel embodiment.

FIG. 17 is a diagrammatic sectional view of a rotary cutter wheel embodiment, illustrating deflection of the cutter wheels with force F applied.

FIGS. 18-21 illustrate different rotary cutter wheel embodiments.

FIG. 22 is a planar view of a cartridge embodiment with a channeled cutting blade.

FIG. 23 is a side view of the cartridge shown in FIG. 22.

FIG. 24 is an opposing side view of the cartridge shown in FIG. 23.

FIG. 25 is an end view of the cartridge shown in FIG. 22.

FIG. 26 is a planar view of a channeled cutting blade included in the cartridge shown in FIG. 22.

FIG. 27 is a front view of the cutting blade shown in FIG. 26.

FIG. 28 is an enlarged sectional view of a portion of an embodiment of the cutting blade shown in FIG. 26.

FIG. 29 is an enlarged sectional view of a portion of another embodiment of the cutting blade shown in FIG. 26.

FIG. 30 is a planar view of an adjustment pin included in the cartridge shown in FIG. 22.

FIG. 31 is a sectional view of a diebond sheet that has been cut with the cartridge shown in FIG. 22.

FIG. 32 is a planar view of an embodiment of the present device for cutting sheet material, including a drive unit.

FIG. 33 is a sectional view of the vertical frame assembly along section line 3-3, including a drive unit.

FIG. 34 is a diagrammatic side view of the vertical frame assembly, illustrating a drive unit.

### DETAILED DESCRIPTION OF THE INVENTION

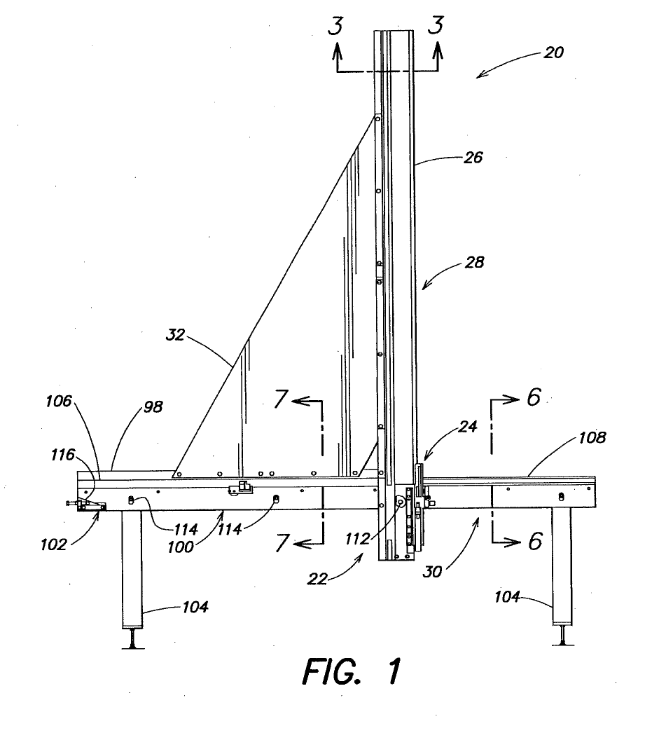

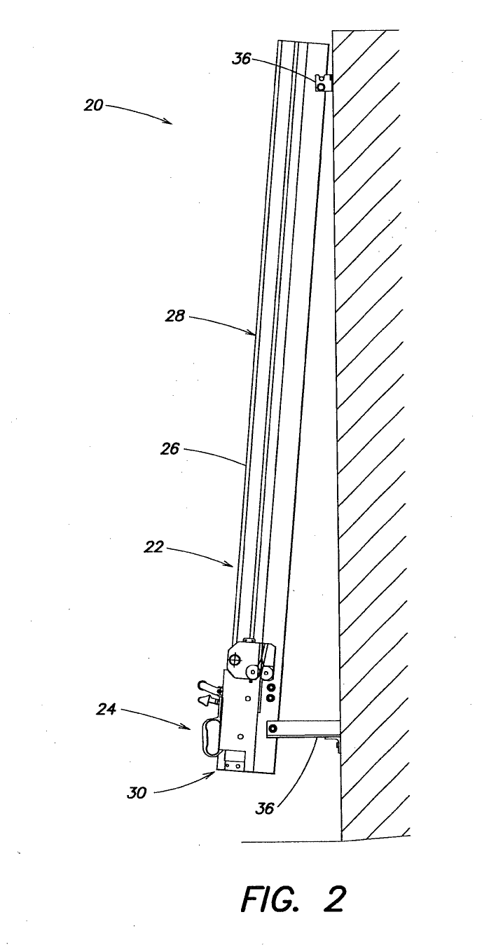

Referring to FIGS. 1 and 2, a device 20 for cutting sheet material is shown that includes a support frame assembly 22 and a cutter head assembly 24 operable to selectively move along a track 26 attached to the support frame assembly 22. The support frame assembly 22 includes a vertical frame assembly 28, a horizontal frame assembly 30, and one or more support panels 32 extending therebetween.

Referring to FIGS. 3A and 3B, the vertical frame assembly 28 includes a vertical frame member 34, a cutter head track 26, a plurality of track spacers 38, and a clamp assembly 40. The term “vertical” as used herein means that the vertical frame assembly 28 is oriented generally perpendicular to the horizontal frame assembly 30 when the device 20 is assembled. In the detailed description provided herein, the vertical frame member 34 is described and shown as being substantially vertical. The device 20 may, however, be positionally oriented otherwise.

The vertical frame member 34 includes a first leg 42, a second leg 44, a web 46 extending between the first and second legs 42, 44, a break-side flange 48, and a panel-side flange 50. In a preferred embodiment, the vertical frame member 34 has a substantially constant cross-section that permits the member 34 to be extruded. The first and second legs 42, 44 extend outwardly from the web 46. The web 46 includes a channel 52 sized to receive a linear rule. Mounting brackets 36 (see FIG. 2) are used to attach the vertical frame member 34 to a wall or other structure. Alternative embodiments mount the device on an independent stand. The distance between the vertical frame member 34 and the wall or other structure, can be adjusted to tilt the device 20 to a desired vertical orientation. In some embodiments, the break-side flange 48 includes a channel 54 for receiving a hardened strip insert 56 to protect the break-side flange 48. In a preferred embodiment, the channel 54 is disposed at an angle “a” relative to the web 46 such that an edge of the hardened strip insert 56 is approximately coplanar with the outer surface of the web 46. The hardened strip insert 56 may be secured within the channel 54 by a variety of different mechanisms including tape, adhesive, conventional fastener, etc. The panel-side flange 50 includes a stepped portion 58 for attachment to one or more support panels 32 as will be described below.

The cutter head track 26 is attached to the vertical frame member 34 via spacers 38. The track 26 extends approximately parallel to the vertical frame member 34. Two or more track spacers 38 are disposed between the vertical frame member 34 and the track 26 to space the track 26 apart from, and mount the track 26 to, the vertical frame member 34. The track 26 includes a first leg 60, a second leg 62, and a web 64 extending between the legs 60, 62 to form a substantially U-shaped cross-sectional geometry having an interior defined by the first leg 60, second leg 62, and web 64. In preferred embodiments, the track 26 has a constant cross-sectional geometry that permits it to be extruded. The track 26 further includes a pair of opposing guide flanges 66 extending outwardly from the second leg 62 for guiding the cutter head assembly 24 as will be described below.

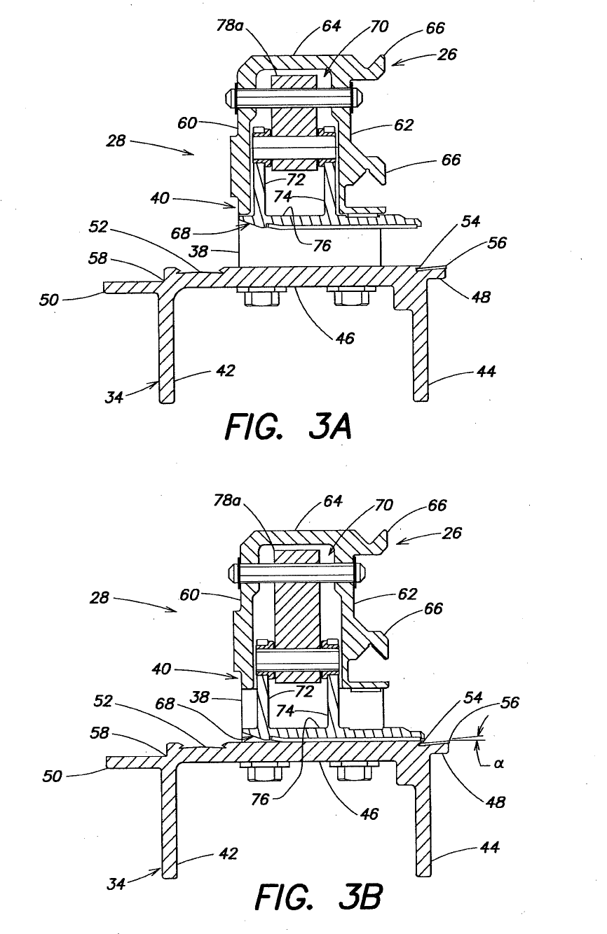

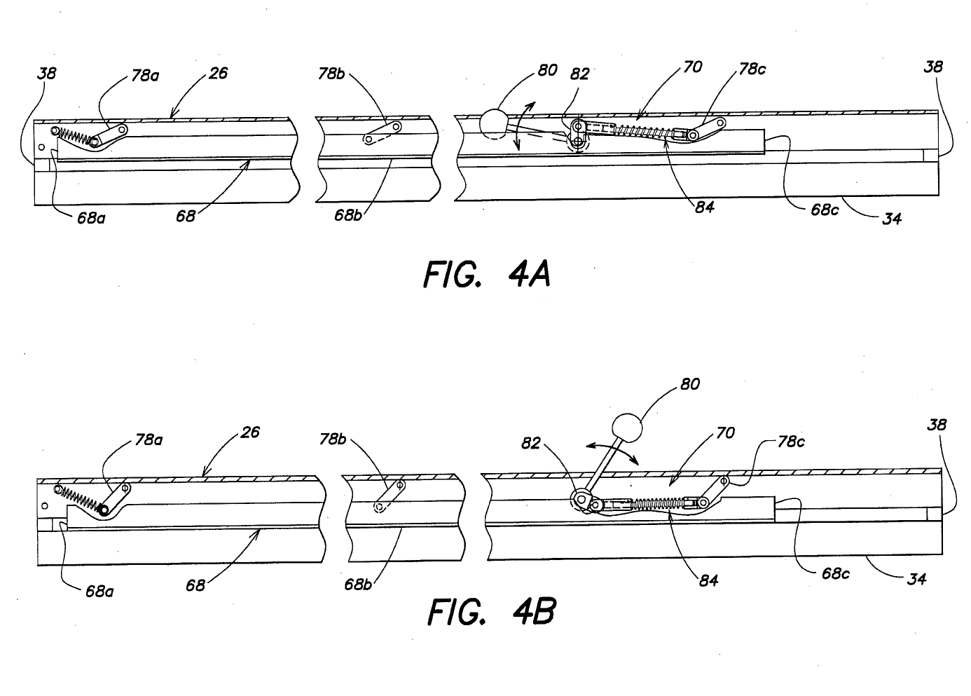

Now referring to FIGS. 3A, 3B, 4A and 4B, the clamp assembly 40 includes a clamp bar 68 and a biasing assembly 70. The clamp bar 68 includes a first leg 72, a second leg 74, and a web 76 extending therebetween and laterally outward from the second leg 74. When assembled, the legs 72, 74 of the clamp bar 68 are received within the interior of the track 26. The clamp bar 68 is attached to the track 26 by a plurality of pivotally mounted links 78a, 78b, 78c that are operable to arcuately pivot the clamp bar 68 between a retracted position adjacent the cutter head track 26, and a deployed position adjacent the vertical frame member 34. The clamp bar 68 remains substantially parallel to the vertical frame member 34 during the travel between the deployed and retracted positions.

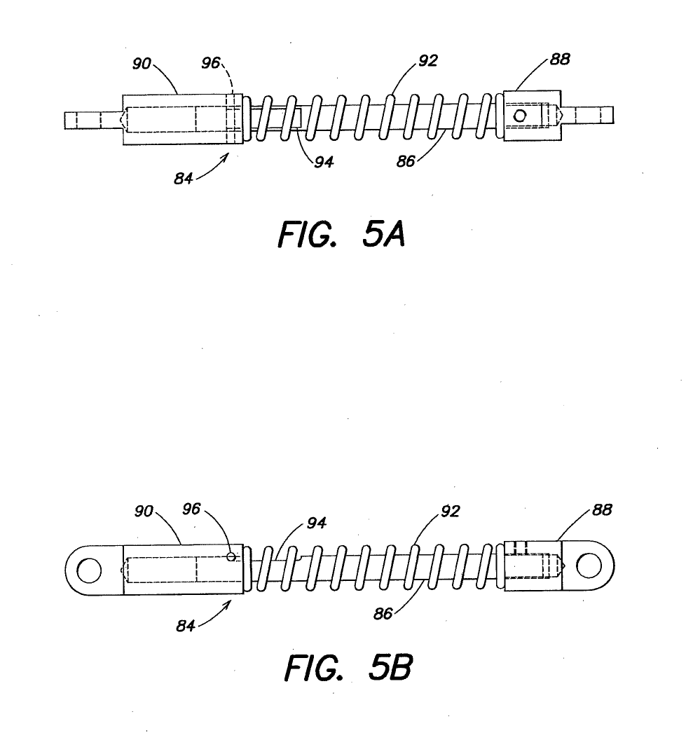

In the embodiment shown in FIGS. 4A, 4B, 5A and 5B, the biasing assembly 70 includes a lever 80, a first link 82 fixed to the lever 80, and a biasing member 84. The biasing member 84 includes a rod 86, a first end flange 88, a second end flange 90, and a coil spring 92. The first end flange 88 is attached to a first end of the rod 86. The second end flange 90 is slidably attached to a second end of the rod 86, opposite the first end of the rod 86. The rod 86 includes a slot 94 disposed adjacent the second end of the rod 86, sized to receive a pin 96. The rod 86 is received within the coil spring 92 and within a portion of the second end flange 90. The rod 86 is connected to the second end flange 90 by the pin 96, which extends through the slot 94. The pin 96 allows the rod 86 and the second end flange 90 to move axially relative to one another without disengaging one another. Axial movement between the rod 86 and the second end flange 90 is limited, however, by the pin 96 contacting the two widthwise ends of the slot 94. The coil spring 92 extends between and acts upon the first and second end flanges 88, 90, thereby biasing the first end flange 88 and attached rod 86 away from the second end flange 90; i.e., toward one end of the permissible travel therebetween. The amount of force provided by the biasing member 84 can be altered by changing the coil spring 92 to one having a different spring rate. The second end flange 90 is pivotally attached to the first link 82 and the first end flange 88 is pivotally attached to the clamp bar 68.

The lever 80, link 82, and biasing member 84 can be rotated into a retracted position as shown in FIG. 4A. From the retracted position, the aforesaid elements can be rotated to a position where the first link 82 and biasing member 84 are axially aligned with one another, and rotated further to a deployed position as shown in FIG. 4B. The deployed position is located a specific rotation angle beyond the axial alignment position (sometimes referred to as an “over the center” position) and thereby creates a detent position where the biasing element 84 holds the elements 80, 82, 84 in place. The force applied by clamp bar 68 via the biasing assembly 70 is greatest when the first link 82 and biasing member 84 are axially aligned with one another, and slightly less in the deployed position. When the biasing assembly 70 is in the deployed position (FIG. 4B), a workpiece can be clamped between the clamp bar 68 and the vertical frame member 34. When the biasing assembly 70 is in the retracted position (FIG. 4A), the clamp bar 68 is disposed in a retracted position away from the workpiece and therefore the vertical frame member 34. The biasing assembly 70 described above is an operable embodiment that provides advantageous clamping and ease of use. The biasing assembly is not limited to this embodiment, however.

In some embodiments, the clamp bar 68 may be slightly crowned in the middle region 68b between ends 68a, 68c. The crown can be created, for example, by a slight curvature of the clamp bar 68, or by a thicker web 76 in the middle region 68b, etc. Alternatively, the crown can be created by causing the clamp bar 68 to deflect slightly in the middle; e.g., by using a link 78b in the middle that is slightly longer than the links 78a, 78c disposed near the end of the clamp bar 68.

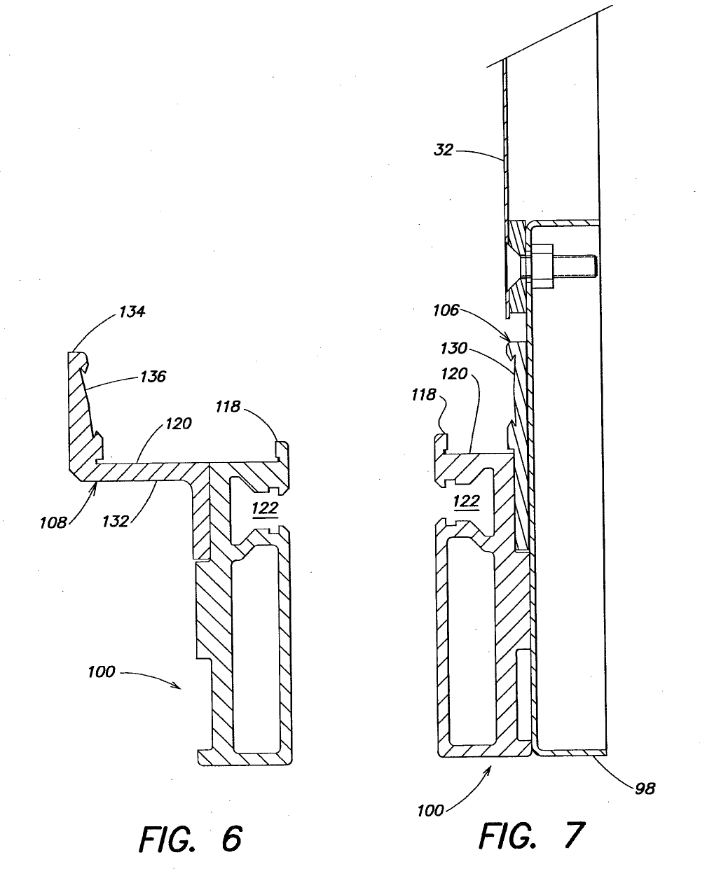

Now referring to FIGS. 1 and 6-8, the horizontal frame assembly 30 includes a static horizontal frame (SHF) member 98, a pivotal horizontal frame (PHF) member 100, an squaring mechanism 102, one or more support legs 104, a support-side tray member 106, and an exit-side tray member 108. The one or more support legs 104 can be adjusted to change the position of the device 20 relative to the floor. The term “horizontal” as used herein means that the horizontal frame assembly 30 is oriented generally perpendicular to the vertical frame assembly 28 when the device 20 is assembled. In the detailed description provided herein, the horizontal frame assembly is described and shown as being substantially horizontal. The device 20 may be positionally oriented otherwise, however.

The SHF member 98 is a C-shaped member that includes a flange attached to one end for attaching the SHF member 98 to the vertical frame member 34. The one or more support legs 104 are attached to the SHF member 98. The one or more support panels 32 extend between and are attached to the SHF member 98 and the vertical frame member 34.

The PHF member 100 is pivotally attached to vertical frame member 34 at a pivot point 112 (see FIG. 1) and can therefore be selectively pivoted relative to the SHF member 98 and the vertical frame member 34. The PHF member may be a single piece that extends along the entire horizontal frame member 30, or it may be sectioned with one section pivotable relative to the vertical frame member 34 (see FIGS. 3A and 3B). One or more fasteners 114 are provided that are operable to fix the PHF member 100 to the SHF member 98. The fastener 114 may be attached to one of the PHF member 100 or the SHF member 98, and travel through a clearance hole or slot in the other of the SHF member 98 or the PHF member 100 to accommodate the relative travel between the members 98, 100. The PHF member 100 includes a ramp surface 116 disposed at or adjacent one end, and a front lip 118 extending outwardly from a top surface 120. In a preferred embodiment, the PHF member 100 has a constant cross-section that permits it to be extruded. The PHF member 100 includes a channel 122 for receiving workpiece positional stops.

The support-side tray member 106 attaches to the PHF member 100 on one side (e.g., the left side facing the device 20) of the vertical frame member 34. The support-side tray member 106 extends away from the PHF member 100 in a direction that is substantially parallel to the front lip 118 of the PHF member 100, thereby forming a channel with the front lip 118 and the top surface 120. The support-side tray member 106 may include a slot 130 for receiving a linear rule. The exit-side tray member 108 attaches to the PHF member 100 on the opposite side (e.g., the right side facing the device 20) of the vertical frame member 34. The exit-side tray member 108 includes a first portion 132 that extends away from the PHF member 100 in a direction that is coplanar with the top surface 120 of the PHF member 100, and a second portion 134 that is substantially parallel to the front lip 118 of the PHF member 100 thereby forming a channel with the front lip 118, top surface 120, and first portion 132. The second portion 134 of the exit-side tray member 108 may include a slot 136 for receiving a linear rule.

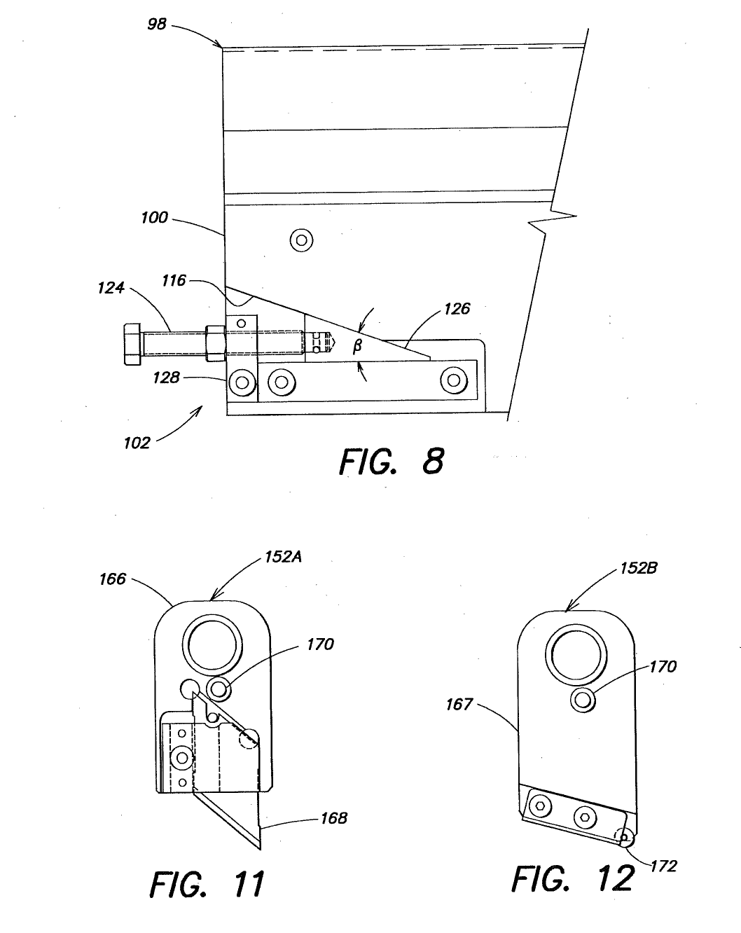

Now referring to FIGS. 1 and 8, the squaring mechanism 102 (also referred to as an angle adjustment mechanism) includes a threaded member 124 pivotally attached to a wedge 126 (e.g., triangular-shaped), and a threaded flange 128. The threaded member 124 is in threaded engagement with the flange 128 (or a nut attached thereto). Rotation of the threaded member 124 is operable to laterally move the wedge 126. The wedge 126 is positioned in contact with the ramp surface 116 of the PHF member 100. Movement of the wedge 126 causes the PHF member 100 to rotate relative to the vertical frame member 34. The rate at which the PHF member 100 rotates relative to the vertical frame member 34 is dictated by the angle “β” of the triangular wedge 126 and the thread per unit length (e.g., coarse thread, fine thread, etc.) of the threaded member 124. The squaring mechanism 102 can be used to set the PHF member 100 perpendicular to the vertical frame member 34, or at some other desired angle.

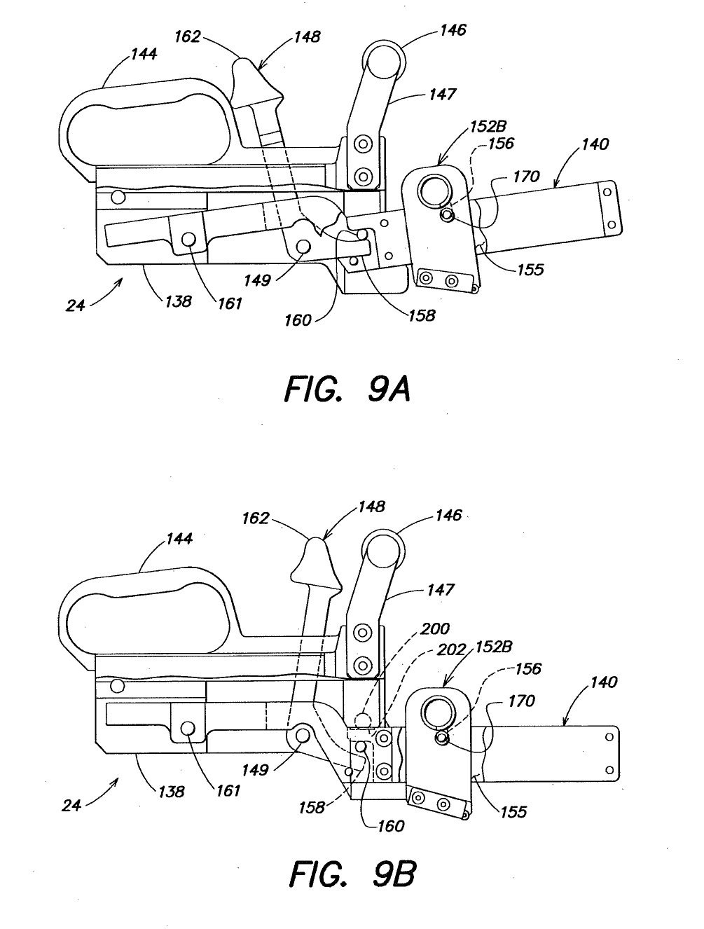

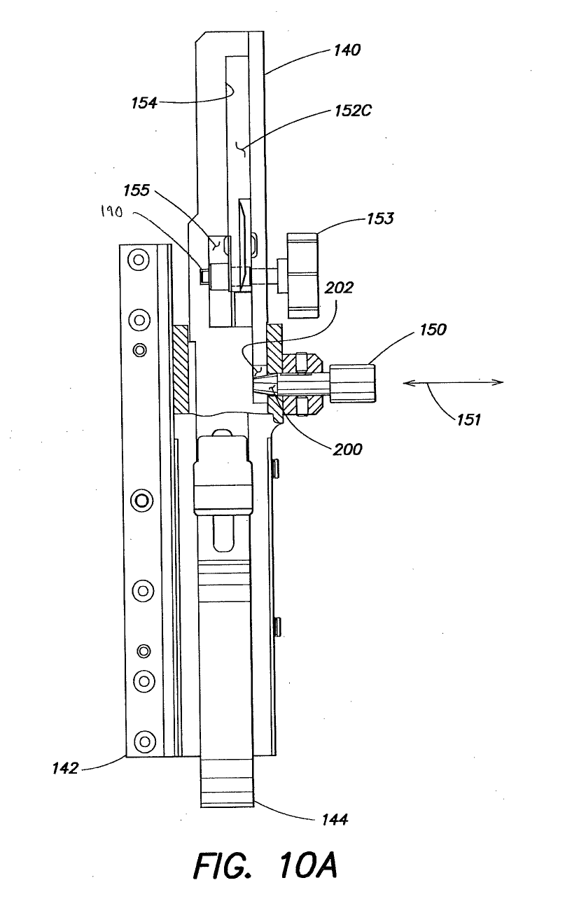

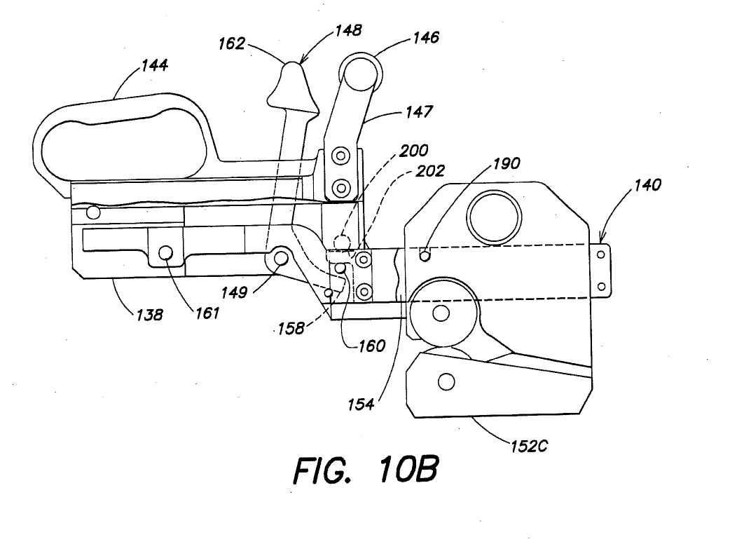

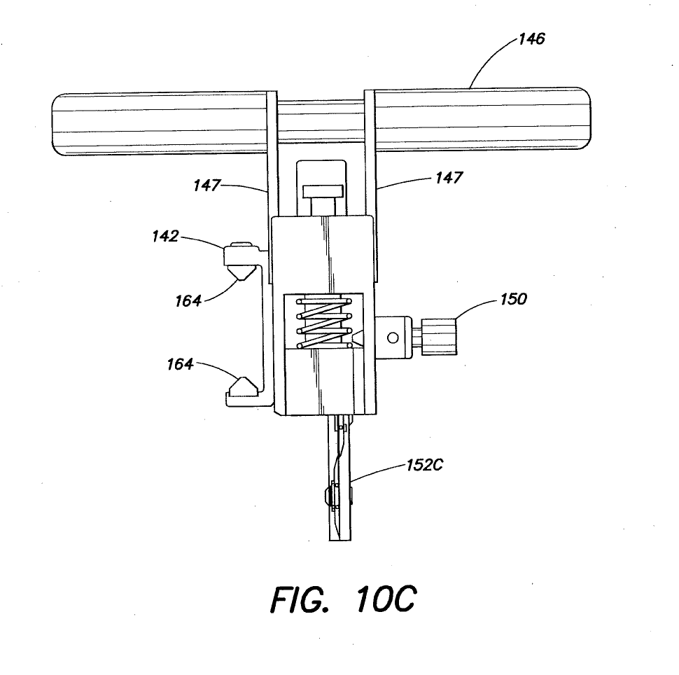

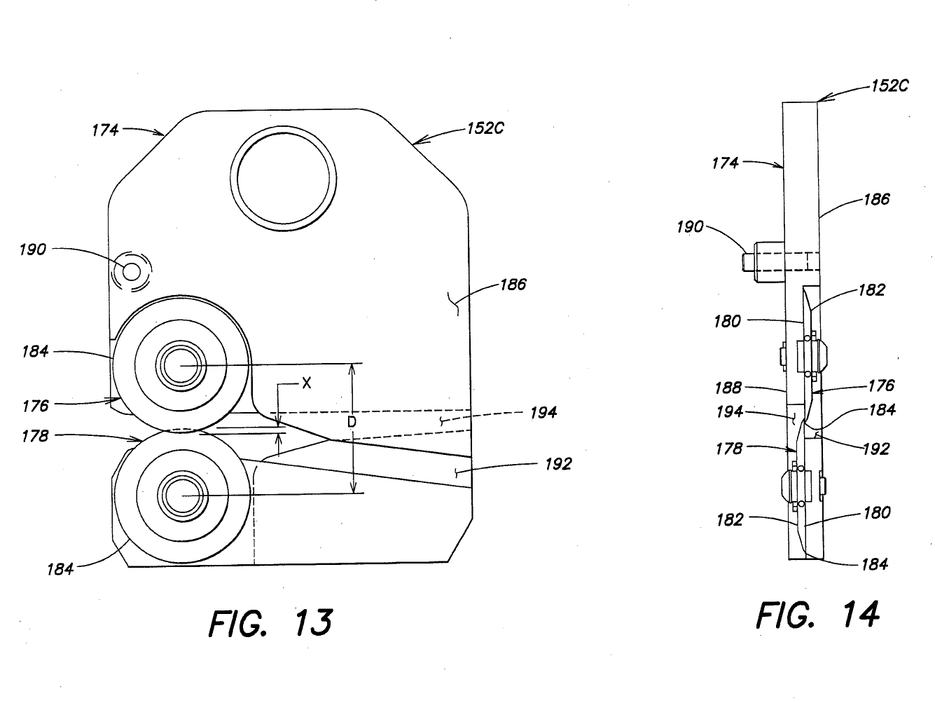

Now referring to FIGS. 9A, 9B, 10A, 10B, and 10C, the cutter head assembly 24 includes a frame 138, a cartridge support arm 140, a track guide 142 (see FIG. 10C), a first handle 144, a second handle 146, a cartridge lift lever 148, a lock screw 153, and a cartridge 152A (see FIG. 11), 152B (see FIG. 12), 152C (see FIG. 13), 152D (see FIG. 22). As will be explained below, there are a variety of different cartridge embodiments that can be used with the cutter head assembly 24. Cartridges 152A, 152B, 152C, and 152D represent examples of acceptable cartridges. The first handle 144 is attached to the frame 138. In the embodiment shown in FIGS. 9A, 9B, 10B, and 10C, the first handle 144 is integrally formed with the frame 138. The second handle 146 (not shown in FIG. 10A), which is attached to the frame 138 by a pair of brackets 147, extends laterally outward from the frame 138; i.e., extends out from the frame 138 in a direction that is substantially perpendicular to the travel direction of the cutter head assembly 24. The lock screw 153 (see FIG. 10A), which is threadably engaged with the support arm 140, can be used to selectively fix a cartridge 152A, 152B, 152C, 152D within the support arm 140. Alternatively, the cartridge can be permitted to float within the support arm 140 pocket.

The cartridge support arm 140 is pivotally attached to the frame 138 to allow the cartridge 152 to be positioned in a deployed position (FIG. 9B) or a retracted position (FIG. 9A). A spring is disposed within the frame 138 to bias the cartridge support arm 140 in the deployed position. A pin 150 slidably engaged with the frame 138 (along the axis of arrow 151—see FIG. 10A) can be positioned to maintain the cartridge support arm 140 in the deployed position or in the retracted position. In a preferred embodiment, the pin 150 has a tapered portion 200 located at its distal end (see FIG. 10A; also shown in phantom in FIGS. 9B and 10B), and a portion of the support arm 140 has a matching tapered surface 202 (see FIGS. 9A and 10A). The tapered surface 202 of the support arm 140 is positioned to align with the tapered portion 200 of the pin 150 when the support aim 140 is located in the deployed position. FIGS. 9B and 10B diagrammatically show the tapered portion 200 of the pin 150 engaged with the tapered surface 202 when the support atm 140 is in the deployed position. The tapered surfaces 200, 202 facilitate alignment between the pin 150 and the support arm 140, and thereby facilitate engagement of the pin 150 with the support arm 140. The cartridge support arm 140 includes one or more pockets 154, 155 for receiving one or more different cartridges 152A, 152B, 152C, 152D. In some embodiments, one or more slots 156 are disposed in the wall of the pocket 154, 155 to receive a locating post 170, 190 as will be explained below.

The cartridge lift lever 148 is pivotally attached to the frame 138. A first end 158 of the lift lever 148 is positioned for engagement with a post 160 attached to the support arm 140. The second end 162 of the lift lever 148 extends toward a position adjacent the first handle 144. If the second end 162 of the lift lever 148 is pulled toward first handle 144, the lift lever 148 will pivot about axle 149 and the first end 158 of the lift lever will contact the post 160. If the lift lever 148 is drawn further toward the first handle 144, the lift lever 148 will cause the cartridge support arm 140 to rotate about axle 161, thereby moving the cartridge support arm 140 into the retracted position. Other mechanisms for pivoting the cartridge support arm 140 may be used alternatively.

Referring to FIG. 10C, the track guide 142 is a C-shaped member that is attached to one side of the frame 138. A pair of opposing guide elements 164 is attached to the interior of the track guide 142. The guide elements 164 are shaped and spaced apart from one another to form a mating pair with the opposing guide flanges 66 extending outwardly from the cutter head track 26. The guide elements 164 form a slide fit with the opposing guide flanges 66 to permit the cutter head assembly 24 to be moved linearly along the cutter head track 26 (see FIGS. 1, 3A and 3B).

The cartridge can assume a variety of different forms (e.g., 152A, 152B, 152C, 152D) operable to cut a variety of different materials. In the embodiment shown in FIG. 11, the cartridge 152A includes a frame 166 and a cutting blade 168 statically mounted relative to the cartridge 152A. The blade 168 is attached to the cartridge 152A in a predetermined position, such that at least a portion of a cutting edge of the blade 168 extends outside the frame 166. The frame 166 includes a locating post 170 attached to the frame 166, extending outwardly from the frame 166. The locating post 170 is positioned to align with the slot 156 disposed in the pocket 155 in the cartridge support arm 140 (see FIGS. 9A and 9B). The locating post 170 and slot 156 ensure the cartridge 152A is properly positioned within the pocket 155, and therefore relative to the cutter head assembly 24.

Now referring to FIG. 12, an alternative cartridge 152B includes a glass scoring wheel 172 pivotally mounted to the frame 167 of the cartridge 152B. In this embodiment, the glass scoring wheel 172 is operable to be placed on a surface of a pane of glass. In alternative embodiments, a single rotary cutter wheel may be used in place of the glass scoring wheel.

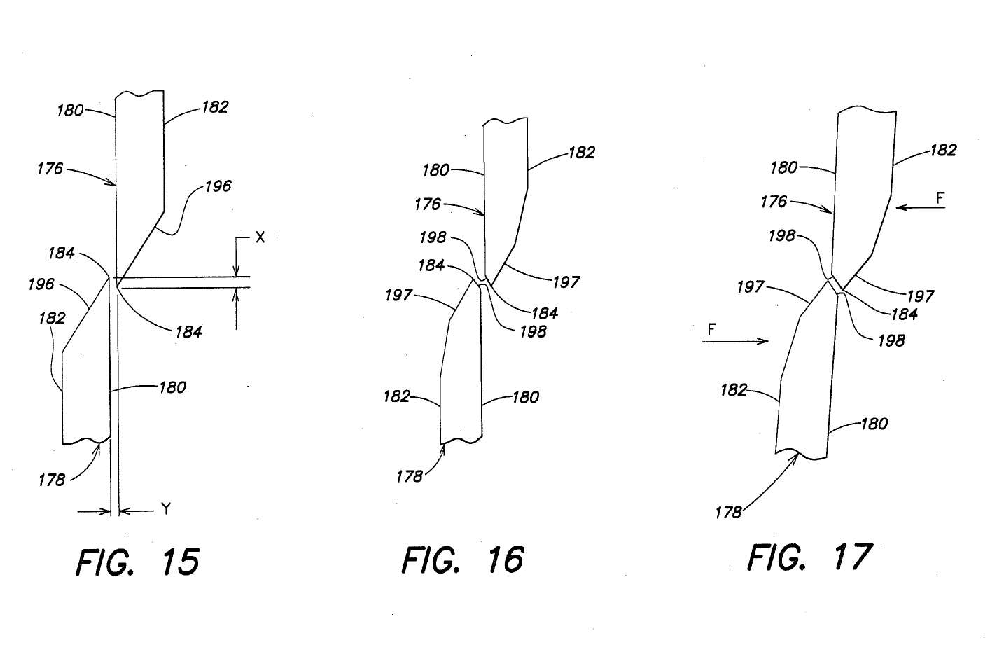

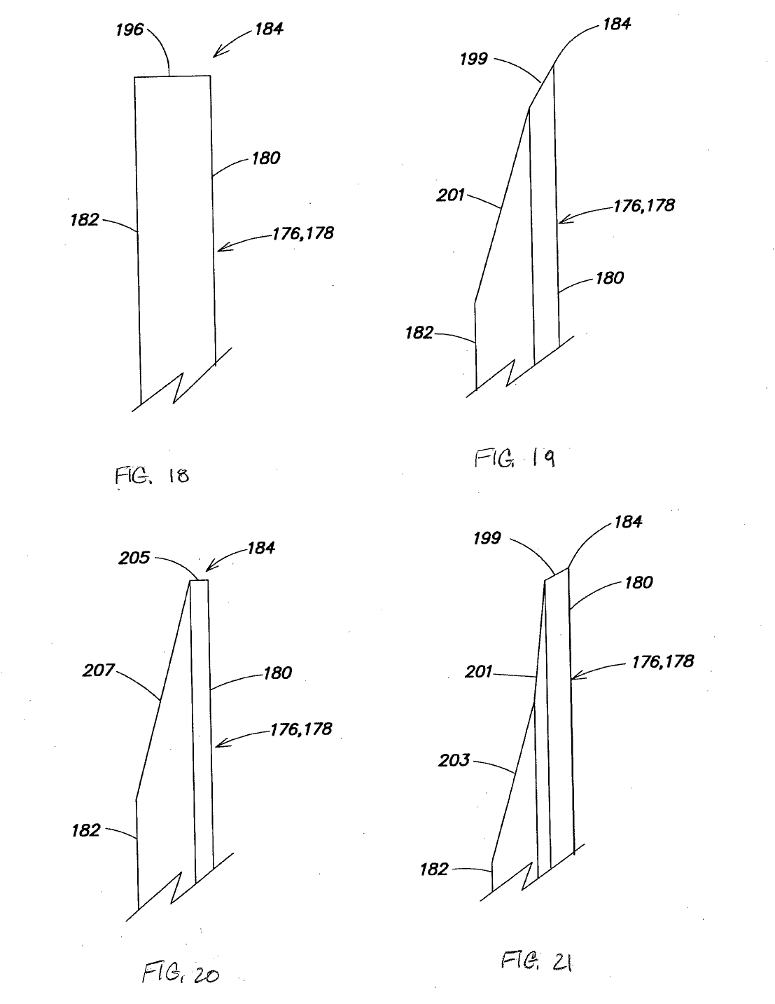

Now referring to FIGS. 13 and 14, in another embodiment, the cartridge 152C includes a frame 174, a first rotary cutter wheel 176, and a second rotary cutter wheel 178. Each cutter wheel 176, 178 has an inner surface 180, an outer surface 182, and a cutting edge 184. The first rotary cutter wheel 176 is disposed on a first side 186 of the frame 174. The second rotary cutter wheel 178 is disposed on a second side 188 of the frame 174 opposite the first side 186. The cutter wheels 176, 178 are mounted on independent axes separated from one another by a predetermined distance “D”. In some embodiments, the distance “D” is chosen to create a radial overlap of magnitude “X” between the cutter wheels 176, 178. The cutter wheels 176, 178 are also spaced on the independent axes to create a lateral separation distance “Y” between cutter wheels 176, 178 (see FIG. 15). The lateral separation distance “Y” can be defined as the distance between chosen similar surfaces of the cutter wheels 176, 178; e.g., the distance between the cutting edges 184, or between the inner surface 180 of each cutter wheel 176, 178, etc. The lateral separation distance “Y” can be accurately created by tolerancing, or shims, etc. Each cutter wheel 176, 178 is preferably mounted on a bearing to facilitate rotation about a defined axis, and minimize wobble of the cutter wheel 176, 178 relative to the axis.

The cartridge frame 174 also includes a locating post 190 attached to the frame 174, extending outwardly from the frame. The locating post 190 is positioned to align with the slot 156 disposed in the pocket 155 within the cartridge support arm 140. The locating post 190 and slot 156 ensure the cartridge 152 is properly positioned within the pocket 154. In some embodiments, the slot 156 has a depth that allows the locating post 190, and therefore the cartridge 152, to float within the slot to facilitate alignment with the workpiece.

The cartridge 152 may further include a first workpiece channel 192 disposed in the first side 186 of the frame 174, and a second workpiece channel 194 disposed in the second side 188 of the frame 174. The workpiece channels 192, 194 are positioned to receive portions of the workpiece sheared by the cutter wheels 176, 178 as will be explained below. The depth of each workpiece channel 192, 194 is chosen such that sheet material portion exiting the cutter wheels 176, 178 readily passes into the workpiece channel 192, 194.

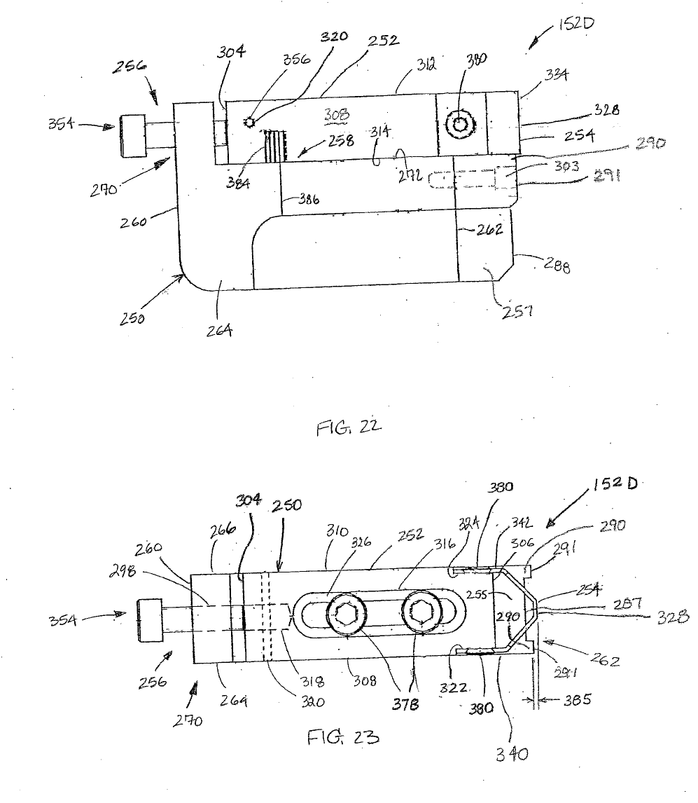

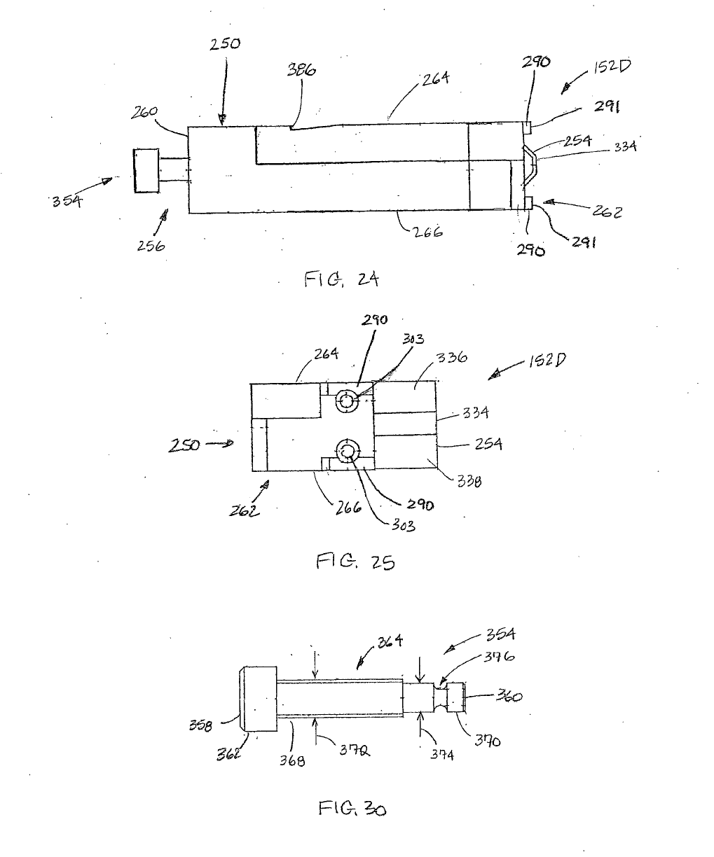

Referring to FIGS. 15-21, the cutter wheel may assume a variety of geometries advantageous for different applications. In the embodiments shown in FIGS. 15 and 18, the cutting edge 184 of a cutter wheel 176, 178 is defined by one edge surface 196 that extends between the inner surface 180 and the outer surface 182. As shown in FIG. 15, the single edge surface 196 extends between the inner and outer surfaces 180, 182 at an angle skewed from the rotational axis of the cutter wheel 176, 178. In FIG. 18, the edge surface 196 extends along a line parallel to the rotational axis of the cutter wheel 176. In other embodiments, the cutting edge 184 maybe defined by a plurality of surfaces disposed between the inner and outer surfaces 180, 182. For example, in FIGS. 16 and 17, the cutting edge 184 is defined by a first edge surface 197 and a second edge surface 198. The first edge surface 197 is disposed between the outer surface 182 and the cutting edge 184, and the second edge surface 198 is disposed between the inner surface 180 and the cutting edge 184. In some embodiments, the cutter wheel 176, 178 may include edge and relief surfaces disposed between the inner surface 180 and the outer surface 182. In FIGS. 19 and 21, the cutting edge 184 is disposed between the inner surface 180 and an edge surface 199. In FIG. 19, a relief surface 201 is disposed between edge surface 199 and the outer surface 182. In FIG. 21, a pair of relief surfaces 201, 203 are disposed between edge surface 199 and the outer surface 182. The cutter wheel embodiment 176, 178 shown in FIG. 20, includes a cutting edge 184 defined by edge surface 205 extending parallel to the rotational axis of the cutter wheel 176, 178 and a relief surface 207 disposed between the edge surface 205 and the outer surface 182. The diagrammatic views of FIGS. 16 and 17 are exaggerated to better illustrate the cutting edge embodiments. The cutting wheels 176, 178 and the cutting edges 184 defined therein are not limited to these exemplary embodiments.

Now referring to FIGS. 16 and 17, an advantage provided by the cutter wheel embodiment having a first edge surface 196 and a second edge surface 198 is that it decreases the chance the cutter wheels 176, 178 will bind with one another when cutting certain materials such as metals, etc. Materials being cut in the rotary cutter wheel embodiment of the cartridge 152C (e.g., as seen in FIGS. 13 and 14) impart a force “F” to the outer surface 182 of the cutter wheels 176, 178 that forces the wheels toward one another. Depending upon the magnitude of that force and the lateral separation distance “Y” between the cutter wheels 176, 178, the wheels can bind with one another. If the force is great enough, the cutter wheels can damage one another. The inclusion of the second cutting edge 198 in the cutter wheels 176, 178, as shown in FIGS. 16 and 17, provides clearance that helps to decrease the chance of interference between the cutter wheels 176, 178, and thereby decrease the chance of undesirable binding. FIG. 17 diagrammatically illustrates a pair of cutter wheels 176, 178, deflecting toward one another under lateral forces F. The second cutting edges 198 permit the cutting wheels 176, 178 to draw closer to one another than would be possible otherwise without interference occurring

Now referring to FIGS. 22-25, in another alternative embodiment the cartridge 152D includes a frame 250, a blade carriage 252, a channeled cutting blade 254, a cutting depth adjustment device 256, and a glide pad 257. In some instances, the cartridge also includes a cutting depth gauge 258 (see FIG. 22).

The frame 250 extends from a first frame end 260 to a second frame end 262, and between a first side surface 264 and a second side surface 266. The frame 250 includes an adjustment segment 270, and a carriage bearing surface 272. In the embodiment shown in FIG. 22, the adjustment segment 270 extends outwardly from the frame 250 adjacent the carriage bearing surface 272. The adjustment segment 270 includes a threaded aperture 298 (see FIG. 23), having an axial centerline that extends substantially parallel to the carriage bearing surface 272. The carriage bearing surface 272 extends between the second frame end 262 and the adjustment segment 270, and between the first and second side surfaces 264 and 266.

Referring to FIGS. 22 and 23, the glide pad 257 includes a frame surface 285, and cutting edge surface 287, and one or more ribs 290 extending outwardly from the cutting edge surface. Each rib 290 has a contact surface 291 One or more fasteners 303 attach the glide pad 257 to the frame 250. The glide pad 257 may be made of the same material as the frame 250, or may be made of an alternative material; e.g., a material that facilitates relative movement between the glide pad 257 and a workpiece. In an alternative embodiment, the glide pad 257 may be incorporated into the frame 250 as a unitary structure.

The blade carriage 252 extends from a first carriage end 304 to a second carriage end 306, between a first side surface 308 and a second side surface 310, and between a third side surface 312 and a frame bearing surface 314. The blade carriage 252 includes an elongated slot 316, an adjustment pin aperture 318, an anchor pin aperture 320, and first and second blade mounts 322 and 324. The elongated slot 316 extends between the third side surface 312 and the frame bearing surface 314. The elongated slot 316 can include a bolt-head nesting region 326 recessed into the third side surface 312. The adjustment pin aperture 318 extends into the blade carriage 252 from the first carriage end 304. The anchor pin aperture 320 extends between the first and second side surfaces 308 and 310, and at least partially intersects the adjustment pin aperture 318. The first blade mount 322 is recessed into the first side surface 308 at the second carriage end 306. The second blade mount 324 is recessed into the second side surface 310 at the second carriage end 306.

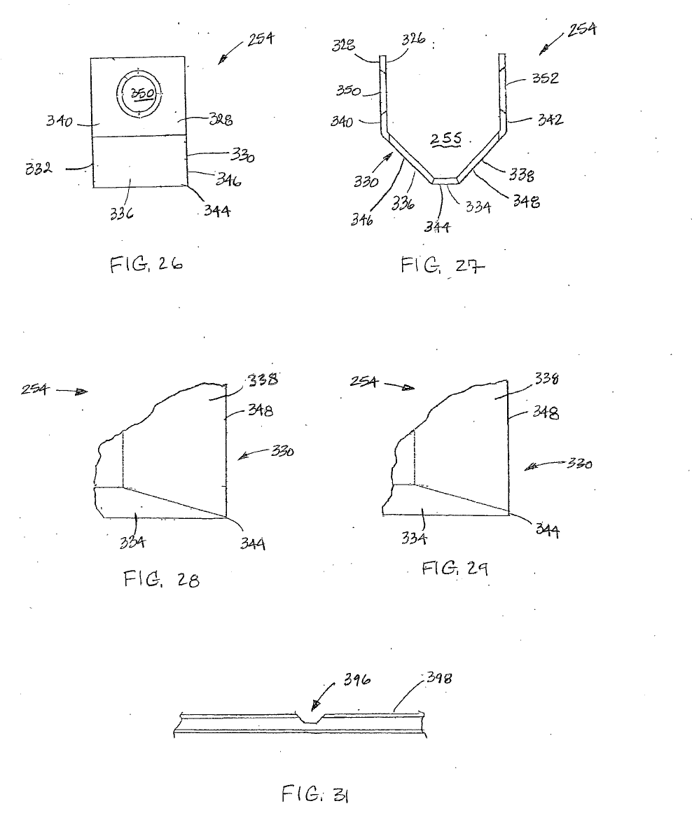

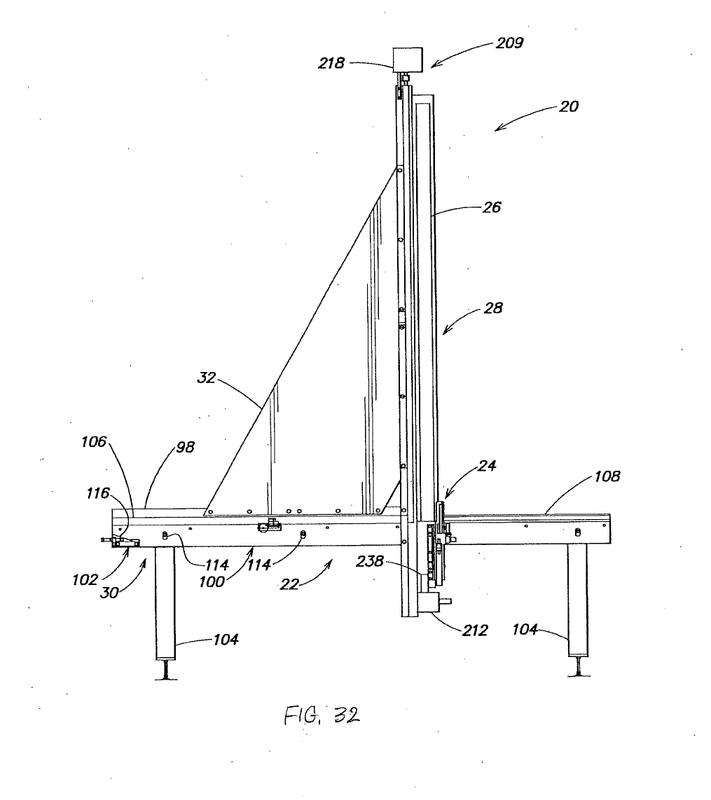

Now referring to FIGS. 26-29, the channeled cutting blade 254 has an inside surface 326, an outside surface 328, and a cross-sectional geometry that extends between a forward end 330 and an aft end 332; e.g., a “U” or a “V” shaped cross-sectional geometry. The cross-sectional geometry of the channeled cutting blade 254 is such that the interior surfaces 326 of the blade 254 define an interior region 255 (see FIGS. 23 and 27). In the embodiment shown in FIG. 27, for example, the cutting blade 254 includes a central cutting segment 334, first and second side cutting segments 336 and 338, and first and second mounting segments 340 and 342. Each cutting segment 334, 336, 338 has a cutting edge 344, 346, 348, respectively, disposed at the forward end 330 of the cutting blade 254. The configuration of the cutting edge 344, 346, 348 can vary to suit the application at hand; e.g. a beveled tip as shown in FIG. 28, or a chamfered tip as shown in FIG. 29. Alternatively, the cutting edges 344, 346, and 348 may not all have the same configuration. The central cutting segment 334 is disposed between the side cutting segments 336 and 338, which are disposed between the mounting segments 340 and 342. Each mounting segment 340, 342 can include a fastener hole 350, 352 that extends between the inside and outside surfaces 326 and 328 of the cutting blade 254.

The cutting blade 254 can be constructed from, but not limited to, RC 58-60 heat treated SAE-1075 carbon steel, etc. The cutting edges can be formed using, for example, electrical discharge machining (EDM) or any other suitable process.

Referring to FIGS. 22, 23 and 30, the cutting depth adjustment device 256 includes an adjustment pin 354 and an anchor pin 356 (see FIG. 22). Referring to FIG. 30, the adjustment pin 354 extends from a first end 358 to a second end 360, and includes a head 362 and a shaft 364. The shaft 364 includes a threaded segment 368 and an anchor segment 370. The threaded segment 368 extends from the head 362 to the anchor segment 370. The anchor segment 370 extends from the threaded segment 368 to the second end 360. The anchor segment 370 includes an annular anchoring notch 376 disposed between the threaded segment 368 and the second end 360.

The frame 250 and the blade carriage 252 are connected together via one or more bolts 378 (see FIG. 23) such that carriage bearing surface 272 is slidably mated with the frame bearing surface 314 (see FIG. 22). The bolts 378 extend through the elongated slot 316 and into the frame 250. Heads of the bolts 378 are seated in the bolt-head nesting region 326 of the elongated slot 316. The mounting segments 340 and 342 of the cutting blade 254 are connected to the blade mounts 322 and 324 on the blade carriage 252 via a plurality of fasteners 380. Each fastener 380 extends through a respective fastener hole 350, 352 (see FIG. 27) and into the blade carriage 252. The thread segment 368 of the adjustment pin 354 is threaded into the threaded aperture 298 in the frame 250. The anchor segment 370 of the adjustment pin 354 is disposed in the adjustment pin aperture 318. The anchor pin 356 is inserted into the anchor pin aperture 320, and is seated in the anchoring notch 376 in the adjustment pin 354 such that the adjustment pin 354 is rotatably connected to the blade carriage 252; i.e., the adjustment pin 354 can rotate relative to the blade carriage 252, but is restrained from axially moving relative to the blade carriage 252.

Referring to FIG. 22, the cutting depth gauge 258 includes a frame position indicator 386 (e.g., a line) and a blade carriage position indicator 384 (e.g., a calibrated scale including a plurality of spaced apart lines). The frame position indicator 386 is scribed into the first side surface 264 of the frame 250. The blade carriage position indicator 384 is scribed in the first side surface 308 of the blade carriage 252. Each line in the blade carriage position indicator 384 shown in FIG. 22 is indicative of a predetermined cutting depth of the cutting blade 254. The term “cutting depth” is used herein to describe a distance 385 between the outside surface 328 of the cutting blade 254 and the contact surfaces 291 of the glide pad 257.

The following examples are provided to illustrate the utility of the present device 20 for cutting sheet material.

### Example I

The present device 20 for cutting sheet materials can be used for cutting mat board commonly used in the process of picture framing. The device 20 is mounted against a wall surface (or independently via a stand) at an appropriate work height and angle by adjusting the bracketry and support leg 104 (or stand). The angle between the PHF member 100 and the vertical frame member 34 is adjusted by actuating the squaring mechanism 102. For example, a squaring mechanism 102 having a wedge 126 with a ramp angle of approximately 20 degrees, and a threaded member 124 having ⅜ inch −24 UNF thread, will provide a vertical change of approximately 0.015 inches per revolution of the threaded member 124. The magnitude of the change in angle of the workpiece relative to the cutter head track 26 will, however, depend on the position of the squaring mechanism 102 relative to the pivot point 112 of the PHF member 100. The cutter head assembly 24 can be positioned to permit a matboard to be inserted into the device 20 by moving the assembly 24 along the track 26 to an upper position.

Once the PHF member 100 and the vertical frame member 34 are square with one another and the cutter head assembly 24 is located out of the way, the matboard is inserted between the clamp bar 68 and the vertical frame member 34. The matboard can be positioned relative to the cutter head assembly 24 using the linear rules provided in the support-side tray member 106, the exit-side tray member 108, and/or the vertical frame member 34.

With the matboard properly positioned, the clamp assembly 40 is actuated from the retracted position to the deployed position. In the deployed position, the biasing assembly 70 biases and maintains the clamp bar 68 in contact with the matboard, thereby clamping it against the vertical frame member 34. The matboard will remain clamped without further action from the operator until the clamp assembly 40 is actuated into the retracted position (i.e., the operator himself is not required to maintain clamp pressure).

In this example, the cutter head assembly 24 utilizes the cartridge 152A having a statically mounted cutting blade 168. The cutter head assembly 24 is moved so that the cutting blade 168 contacts the matboard, and then is subsequently drawn across the matboard to perform the cut. Once the cut is made, the cutter head assembly 24 is secured out of the way, the clamping assembly 40 is actuated into a retracted position, and the matboard is removed from the device 20, or shifted to a new desired position.

Examples of other sheet materials that can be cut with the present device 20 using a cartridge 152 A with a static cutting blade 168, include PVC, foamboard, wood veneer, corrugated vinyl, etc.

### Example II

The present device 20 for cutting sheet materials can also be used to cut diebond (e.g., corrugated panels including outer layers consisting of sheet metal), which is commonly used for signage. The device 20 is mounted similar to the manner described above under Example I.

Once the PHF member 100 and the vertical frame member 34 are square with one another and the cutter head assembly 24 is located out of the way, the diebond sheet is inserted between the clamp bar 68 and the vertical frame member 34. The diebond sheet can be positioned relative to the cutter head assembly 24 using the linear rules provided in the support-side tray member 106, the exit-side tray member 108, and/or the vertical frame member 34. With the diebond sheet properly positioned, the clamp assembly 40 is actuated from the retracted position to the deployed position, hi the deployed position, the biasing assembly 70 biases and maintains the clamp bar 68 in contact with the diebond, thereby clamping it against the vertical frame member 34.

In this example, the cutter head assembly 24 utilizes the cartridge 152C having rotary cutter wheels 176, 178. The cutter head assembly 24 is moved so that the diebond sheet is drawn between the rotary cutter wheels 176, 178 and the assembly 24 is subsequently drawn across the diebond sheet to perform the cut. In some embodiments, the cartridge 152C is mounted to “float” within the cutter assembly 24 to facilitate alignment between the rotary cutter wheels 176, 178 and the diebond workpiece. As the diebond sheet passes through the rotary cutter wheels 176, 178, one cut sheet portion is guided within the first workpiece channel 192 in a first direction and the other cut sheet portion is guided within the second workpiece channel 194 in a second direction away from the first direction. Once the cut is made, the cutter head assembly 24 is secured out of the way, the clamping assembly 40 is actuated into a retracted position, and the diebond sheet is removed from the device 20.

Examples of other sheet materials that can be cut with the present device 20 using a cartridge 152C with rotary cutter wheels 176,178 include sheet metal, alumalite, etc.

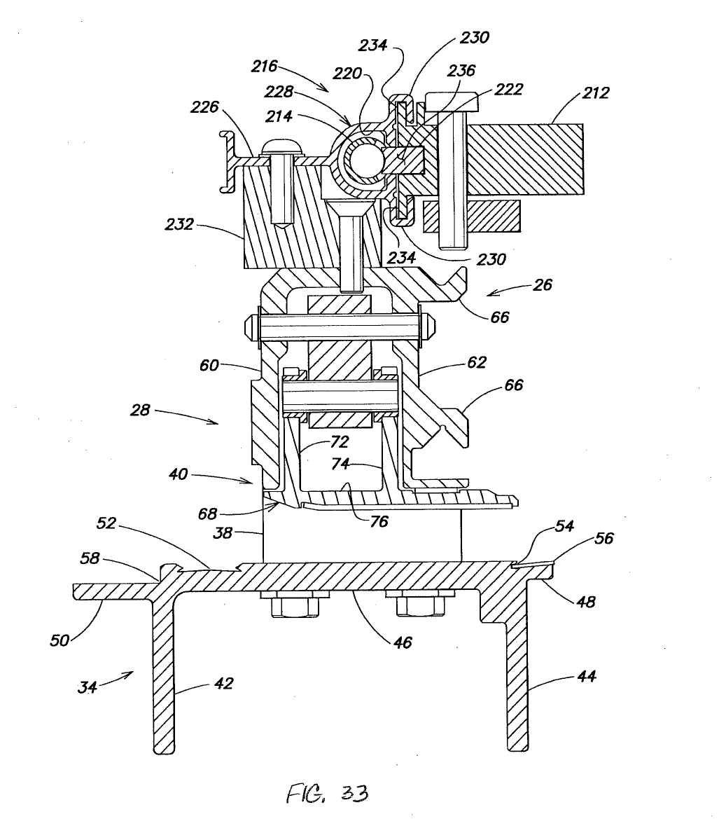

Alternatively, the cutter head assembly 24 can utilize the cartridge 152D shown in FIG. 22 to cut a shaped channel 396 (e.g., V″ or “U” shaped) into the sheet 398 (e.g., a diebond sheet) as shown in FIG. 31. A slice of the material being cut by the cartridge 152D (i.e., the material removed from the sheet) is received within the interior region 255 of the blade 254. The depth of the channel 396 into the sheet 398 can be adjusted using the cutting depth adjustment device 256 and the cutting depth gauge 258. The adjustment pin 354, for example, can be turned to slide the blade carriage 252 relative to the frame 250 until adjusted to the desired depth of cut. The amount of relative change between the frame 250 and the blade carriage 252 is indicated by the frame position indicator 386 and the blade carriage position indicator 384. The cutter head assembly 24 is subsequently moved across the sheet to perform the notched cut into the sheet. Once the cut is made, the cutter head assembly 24 can be secured out of the way, the clamping assembly 40 actuated into a retracted position, and the workpiece sheet removed from the device 20.

Now referring to FIGS. 32-34, in an alternative embodiment, the device 20 includes a linear drive unit 209 operable to power the cutter head assembly 24 along the cutter head track 26. The linear drive unit 209 may provide power via a fluid cylinder, or by a motor coupled with a flexible member (e.g., a chain, cable, or belt), or a linear gear (e.g., a rack and pinion), or a threaded member coupled with a linear slide, or combinations thereof. The drive unit includes a controller that enables operator control of the cutter head assembly 24 along substantially all of the length of the cutter head track 26, or portions thereof, in both directions. Operator input to the controller may occur by electrical controls (e.g., switches, CPU, etc.) hardwired to the controller, or by radio operated wireless controls, or some combination thereof. The drive unit 209 may also include safety controls that are operably connected to the controller to prevent predetermined operating conditions.

In a drive unit 209 embodiment that includes a fluid cylinder, the fluid cylinder may, for example, be a pneumatic cylinder that has a cylinder housing and a double-acting rod. In most applications, the actuable length of the rod is equal to or greater than the travel of the cutter head assembly 24 on the cutter head track 26. The cylinder housing may be attached to the either the cutter head track 26 or the vertical frame member 34. The rod is attached to the cutter head assembly 24. The controller may be appropriate pneumatic valving that permits the operator to control actuation of the rod into and out of the cylinder housing, thereby moving the cutter head assembly 24 along the cutter head track 26.

In a drive unit 209 embodiment that includes a motor driven flexible member, the flexible member may be in the faun of a chain, cable, belt, or the like, arranged in a closed loop. An electrical drive motor and drive pulley (or drive gear) is disposed adjacent one end of the cutter head track 26, and a non-driven pulley (or gear) is disposed adjacent the other end of the cutter head track. The flexible member is attached to the cutter head assembly 24. Rotating the drive pulley clockwise causes the cutter head assembly to be drawn along the cutter head track in a first direction. Rotating the drive pulley counterclockwise causes the cutter head assembly to be drawn along the cutter head track in a second direction, opposite the first direction.

In a drive unit 209 embodiment that includes a linear gear, a gear mounted on a motor may be engaged with a linear gear. The linear gear is attached to the cutter head assembly 24. Rotation of the motor mounted gear clockwise causes the cutter head assembly 24 to be drawn along the cutter head track 26 in a first direction. Rotating the motor mounted gear counterclockwise causes the cutter head assembly 24 to be drawn along the cutter head track 26 in a second direction, opposite the first direction.

In a drive unit 209 embodiment that includes a threaded member assembly coupled with a linear slide 212, the threaded member assembly includes a screw 214 disposed within a guide rail 216. The screw 214 maybe a one piece unit or a plurality of connected sections that collectively have a length that is, in most applications, equal to or greater than the travel of the cutter head assembly 24 on the cutter head track 26. One end of the screw 214 is coupled to a motor 218 that is operable to rotate the screw 214 clockwise and counterclockwise.

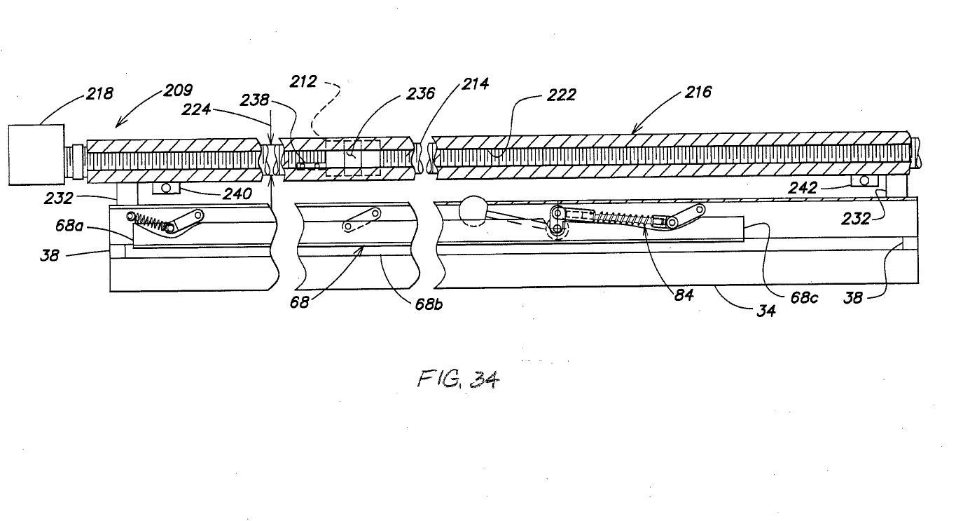

The guide rail 216 includes a cylindrical bore 220 (see FIG. 33) having an internal diameter large enough to receive the outer diameter of the screw 214 with a slide fit therebetween. The internal diameter surface of the cylindrical bore 220 may include a wear-resistant surface applied directly to the cylindrical bore 220, or a wear-resistant liner may be disposed within the cylindrical bore 220. The guide rail 216 includes a window 222 that permits access to cylindrical bore 220. The window 222 extends continuously along substantially the entire length of the cylindrical bore 220. The window 222 has a width 224 great enough to permit engagement of the screw 214, but small enough to prevent the screw 214 from exiting the cylindrical bore 220 through the window 222.

In the embodiment shown in FIGS. 32-34, the guide rail 216 includes a rib 226, a screw housing 228 containing the cylindrical bore 220, and a pair of opposed u-shaped slide flanges 230. The rib 226 is attached to a first side of the screw housing 228, and the pair of opposed u-shaped flanges 230 are attached to a second side of the screw housing 228, substantially opposite the first side. The window 222 is disposed within the screw housing 228, located between the u-shaped flanges 230.

The guide rail 216 may be attached to, or incorporated within, the cutter head track 26 or the vertical frame member 34. In the embodiment shown in FIGS. 32-34, the guide rail 216 is shown attached to the cutter head track 26. The present invention is not limited to this embodiment, however. A plurality of spacer blocks 232 separate the cutter head track 26 from, and maintain it parallel to, the guide rail 216.

The linear slide 212 includes a flange 234 sized to be received within the u-shaped flanges 230 of the guiderail 216, a selectively engageable member 236, and a flange 238 for attachment to the cutter head assembly 24. The selectively engageable member 236 includes a threaded section that mates with the thread of the screw 214. It can be selectively engaged with the screw 214 through the window 222 within the screw housing 228. Once engaged, the slide 212 can only be moved along the guide rail 216 (and therefore the cutter head track 26) by rotation of the screw 214. When disengaged, the slide 212 can be freely moved along the guide rail 216 (and therefore the cutter head track 26).

An upper limit switch 240 is attached to the guide rail 216 at a position intended to be the maximum upper position of the slide 12 (and therefore the cutter head assembly 26). Likewise, a lower limit switch 242 is attached to the guide rail 216 at a position intended to be the maximum lower position of the slide 216. A limit switch engagement arm is attached to the slide 216 to actuate the limit switches 240, 242 at the appropriate travel position. The limit switches 240, 242 are electrically connected to the controller to stop the electrical motor 218. Alternative embodiments may use different travel sensors such as rotary encoders, etc.

In the operation of the device 10, the operator positions the cutter head assembly 24 above a workpiece prior to making the cut. Once the workpiece is positioned and clamped, the operator starts the drive unit, which in turn begins to drive the cutter head assembly 24 downward along the cutter head track 26. The workpiece is engaged by the cartridge 152 within the cutter head assembly 24 and is cut as the cutter head assembly 24 travels along the cutter head track 26. After the cutter head assembly 24 has finished the cut, it will continue to travel until the lower limit switch 242 is actuated.

Although this invention has been shown and described with respect to the detailed embodiments thereof, it will be understood by those skilled in the art that various changes in form and detail thereof may be made without departing from the spirit and the scope of the invention.

What is claimed is:

1. An apparatus for cutting a workpiece sheet, which sheet includes a surface, comprising:
a frame extending between a first end and a second end, which frame includes a carriage bearing surface that extends between the second end and the first end;
a blade carriage having a frame bearing surface, which frame bearing surface is configured to mate with the carriage bearing surface, and which blade carriage is selectively attachable to the frame such that the carriage bearing surface and the frame bearing surface are engaged with one another; and
a channeled cutting blade mounted to the blade carriage, which channeled cutting blade has an interior surface and an exterior surface;
wherein the frame and the blade carriage are relatively positionable such that at least a portion of the channeled cutting blade extends outwardly from the frame an amount that permits the cutting blade to engage and cut a channel in the surface of the workpiece sheet.

2. The apparatus of claim 1, wherein the interior surface of the cutting blade defines an interior region of the cutting blade.

3. The apparatus of claim 2, wherein the cutting blade includes a first side cutting segment and a second side cutting segments, which segments are disposed on opposite sides of the interior region.

4. The apparatus of claim 3, wherein the cutting blade further comprises a central cutting segment extending between the first side cutting segment and the second side cutting segment.

5. The apparatus of claim 4, wherein the first side cutting segment, the second side cutting segment, and the central cutting segment each has one of a beveled tip and a chamfered tip.

6. The apparatus of claim 1, further comprising a cutting depth adjustment device that is operable to move the blade carriage and attached channeled cutting blade relative to the frame.

7. The apparatus of claim 6, wherein the cutting depth adjustment device includes an adjustment pin including a threaded portion engaged with the frame and an anchor segment mounted in the blade carriage, wherein rotation of the adjustment pin produces relative motion between the frame and the blade carriage, and the cutting blade attached to the blade carriage.

8. The apparatus of claim 1 further comprising a glide pad attached to the second end of the frame adjacent the cutting blade.

9. The apparatus of claim 8, wherein the glide pad includes at least one rib extending outwardly from a cutting edge surface, which rib has a contact surface.

10. The apparatus of claim 9, wherein the apparatus has a cutting depth defined by the distance between exterior surface of the cutting blade and the contact surface of the rib.

11. A workpiece sheet cutting device, comprising:
a frame member;
a track attached to the frame member;
a clamp assembly for selectively fixing the workpiece sheet to the frame member;
a cutter head assembly that is linearly translatable along the track; and
a cartridge selectively attachable to the cutter head assembly, which cartridge includes a frame extending between a first end and a second end, which frame includes a carriage bearing surface that extends between the second end and the first end, a blade carriage having a frame bearing surface, which frame bearing surface is configured to mate with the carriage bearing surface, and which blade carriage is selectively attachable to the frame such that the carriage bearing surface and the frame bearing surface are engaged with one another, and a channeled cutting blade mounted to the blade carriage, which channeled cutting blade has an interior surface and an exterior surface, wherein the frame and the blade carriage are relatively positionable such that at least a portion of the channeled cutting blade extends outwardly from the frame an amount that permits the cutting blade to engage and cut a channel in the surface of the workpiece sheet.

12. The device of claim 11, wherein the interior surface of the cutting blade defines an interior region of the cutting blade.

13. The device of claim 12, wherein the cutting blade includes a first side cutting segment and a second side cutting segments, which segments are disposed on opposite sides of the interior region.

14. The device of claim 13, wherein the cutting blade further comprises a central cutting segment extending between the first side cutting segment and the second side cutting segment.

15. The device of claim 14, wherein the first side cutting segment, the second side cutting segment, and the central cutting segment each has one of a beveled tip and a chamfered tip.

16. The device of claim 11, further comprising a cutting depth adjustment device that is operable to move the blade carriage and attached channeled cutting blade relative to the frame.

17. The device of claim 16, wherein the cutting depth adjustment device includes an adjustment pin including a threaded portion engaged with the frame and an anchor segment mounted in the blade carriage, wherein rotation of the adjustment pin produces relative motion between the frame and the blade carriage, and the cutting blade attached to the blade carriage.

18. The device of claim 11 further comprising a glide pad attached to the second end of the frame adjacent the cutting blade.

19. The device of claim 18, wherein the glide pad includes at least one rib extending outwardly from a cutting edge surface, which rib has a contact surface.

20. The device of claim 19, wherein the apparatus has a cutting depth defined by the distance between exterior surface of the cutting blade and the contact surface of the rib.
